(19) United States
(12) Patent Application Publication
(10) Pub. No.: US 2018/0154451 A1
(43) Pub. Date: Jun. 7, 2018

(54) PRODUCTION OF POROUS GOLD NANOPARTICLES

(71) Applicants: Fatemeh Hakimian, Yazd (IR); Hedayatollah Ghourchian, Tehran (IR)

(72) Inventors: Fatemeh Hakimian, Yazd (IR); Hedayatollah Ghourchian, Tehran (IR)

(21) Appl. No.: 15/856,046

(22) Filed: Dec. 27, 2017

Related U.S. Application Data
(60) Provisional application No. 62/470,263, filed on Mar. 12, 2017.

(51) Int. Cl. B22F 9/24; B22F 1/00

(52) U.S. Cl. CPC B22F 9/24; B82Y 30/00; B22F 1/0018

(57) ABSTRACT

A method for synthesizing porous gold nanoparticles is disclosed. The method includes synthesizing gold nanoparticles by reducing HAuCl₄, as well as stabilizing the synthesized gold nanoparticles by mixing a surfactant with the synthesized gold nanoparticles. The method further includes adding an acid solution to the stabilized gold nanoparticles in order to form porous gold nanoparticles, and separating the acid solution and excess reducing agent from the synthesized porous gold nanoparticles. The method provides a more efficient means of obtaining porous gold nanoparticles.

### CROSS-REFERENCE TO RELATED APPLICATION

This application claims the benefit of priority from pending U.S. Provisional Patent Application Ser. No. 62/470,263, filed on Mar. 12, 2017, and entitled “SIMPLE AND RAPID SYNTHESIS OF POROUS GOLD NANOPARTICLES TO INCREASE DNA LOADING,” which is incorporated herein by reference in its entirety.

### TECHNICAL FIELD

The present disclosure relates to methods for synthesizing porous gold nanoparticles.

### BACKGROUND

Metallic nanoparticles, such as gold nanoparticles, offer benefits in many potential applications due to their low density and effective contact area. These applications occur across a wide range of fields and research activities, including catalysis, plasmonics, drug delivery, magnetic memories, biomedical imaging, and DNA detection. Porous gold nanoparticles may be suitable for application in catalysis, sensors, actuators, as well as in electrodes for electrochemical supercapacitors due to the unique structural, mechanical and chemical properties of the porous gold nanoparticles. Porous gold nanoparticles possess a greater surface-to-volume ratio relative to gold nanoparticles and bulk nanoporous gold films. Thus, porous gold nanoparticles are expected to significantly broaden the applications of gold nanoparticles due to their two-level nanostructures, i.e., nano size and nano porosities.

One method for synthesizing porous gold nanoparticles is dealloying Au—Ag alloys through dissolution of Ag in a corrosive environment. In this dealloying method, different microstructural features may be produced, depending on the initial alloy composition. Although the dealloying method is capable of synthesizing porous gold nanoparticles with generally acceptable performance parameters, there remains a need for relatively simple, rapid, and cost-effective methods that are capable of producing small-sized porous gold nanoparticles.

### SUMMARY

This summary is intended to provide an overview of the subject matter of the present disclosure, and is not intended to identify essential elements or key elements of the subject matter, nor is it intended to be used to determine the scope of the claimed implementations. The proper scope of the present disclosure may be ascertained from the claims set forth below in view of the detailed description below and the drawings.

In one general aspect, the present disclosure describes a method for synthesizing porous gold nanoparticles. The method may include one or more of the following steps: synthesizing gold nanoparticles by reducing HAuCl₄, stabilizing the synthesized gold nanoparticles by mixing a surfactant with the synthesized gold nanoparticles, adding an acid solution to the stabilized gold nanoparticles in order to form porous gold nanoparticles, and/or separating the acid solution and excess reducing agent from the synthesized porous gold nanoparticle.

The above general aspect may include one or more of the following features. In one example, synthesizing gold nanoparticles by reducing HAuCl₄ can include the use of a reducing agent. in some implementations, synthesizing gold nanoparticles by reducing HAuCl₄ by a reducing agent may further include preparing a solution of HAuCl₄, heating the solution of HAuCl₄ to a temperature close to a boiling point of the solution of HAuCl₄ and mixing a solution of the reducing agent with the heated solution of HAuCl₄. In some cases, preparing a solution of HAuCl₄ can include preparing a solution of HAuCl₄ with a concentration between approximately 650 μM and 850 μM. In another example, mixing the solution of the reducing agent with the heated solution of HAuCl₄ may include mixing the solution of the reducing agent with a concentration between approximately 1 μM and 3 mM with the heated solution of HAuCl₄. In one implementation, the reducing agent includes trisodiumcitrate. In some other cases, the acid solution includes an HNO₃ solution. In some implementations, the surfactant is selected from the group consisting of polysorbate 20, polysorbate 40, polysorbate 60, polysorbate 80, cetyltrimethylammonium bromide (CTAB), and polyethylene glycol p-(1,1,3,3-tetramethylbutyl)-phenyl ether. In another example, mixing the surfactant with the synthesized gold nanoparticles can include mixing the surfactant with a concentration between approximately 1 μM and 200 μM with the synthesized gold nanoparticles. Furthermore, in another example, adding the acid solution to the stabilized gold nanoparticles in order to form porous gold nanoparticles can include adding the acid solution with a concentration between approximately 1×10⁻⁶ M and 2 M to the stabilized gold nanoparticles.

In addition, in one implementation, separating the acid solution and excess reducing agent from the synthesized porous gold nanoparticles is carried out by centrifugation. In another implementation, the synthesized porous gold nanoparticles have an average diameter of 17.6 nm. In some cases, the synthesized porous gold nanoparticles have an average zeta potential of −11.07±1.46 mV. In another example, the synthesized gold nanoparticles are smaller in diameter than the synthesized porous gold nanoparticles. Furthermore, the synthesized gold nanoparticles may be smaller in diameter than the synthesized porous gold nanoparticles. In another implementation, the synthesized porous gold nanoparticles are approximately 1 nm larger in diameter than the synthesized gold nanoparticles. In some implementations, the synthesized gold nanoparticles include a smoother outer surface relative to an outer surface of the synthesized porous gold nanoparticles. In one implementation, the method may further include adding a first solution of Tween 20 to the stabilized gold nanoparticles to obtain a second solution containing porous Tween-capped gold nanoparticles. In some implementations, DNA loading for the porous Tween-capped gold nanoparticles is at least three times greater than DNA loading for the synthesized gold nanoparticles. In addition, in some cases, the porous Tween-capped gold nanoparticles have an average diameter of approximately 17.1 nm.

Other systems, methods, features and advantages of the implementations will be, or will become, apparent to one of ordinary skill in the art upon examination of the following figures and detailed description. It is intended that all such additional systems, methods, features and advantages be included within this description and this summary, be within the scope of the implementations, and be protected by the following claims.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 illustrates a method for synthesizing porous gold nanoparticles according to an implementation of the present disclosure;

FIG. 2 presents percentages of DNA loading of gold nanoparticles, Tween-capped gold nanoparticles and porous Tween-capped nanoparticles, according to an implementation of the present disclosure;

FIG. 3A illustrates a three-dimensional Atomic Force Microscopy (3D AFM) image of the gold nanoparticles as synthesized in Example 1, according to an implementation of the present disclosure; and

FIG. 3B illustrates 3D AFM image of porous gold nanoparticles as synthesized in Example 3, according to an implementation of the present disclosure.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

The following detailed description is presented to enable a person skilled in the art to make and use the methods and devices disclosed in exemplary embodiments of the present disclosure. For purposes of explanation, specific nomenclature is set forth to provide a thorough understanding of the present disclosure. However, it will be apparent to one skilled in the art that these specific details are not required to practice the disclosed exemplary embodiments. Descriptions of specific exemplary embodiments are provided only as representative examples. Various modifications to the exemplary implementations will be readily apparent to one skilled in the art, and the general principles defined herein may be applied to other implementations and applications without departing from the scope of the present disclosure. The present disclosure is not intended to be limited to the implementations shown, but is to be accorded the widest possible scope consistent with the principles and features disclosed herein

As discussed above, there is a need for a more effective method of synthesizing porous gold nanoparticles The present application discloses a novel method for the synthesis of porous gold nanoparticles that is relatively low in complexity and also allows for the production porous gold nanoparticles with improved specific surface areas.

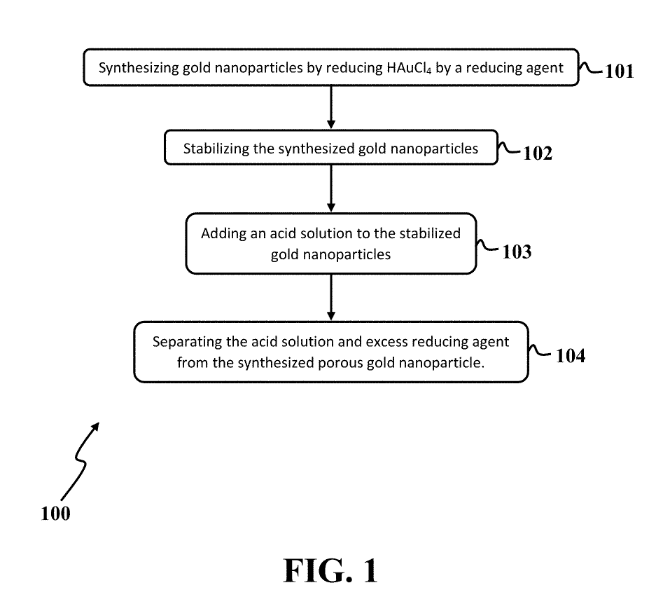

Referring first to FIG. 1, an overview of an implementation of a method 100 for synthesizing porous gold nanoparticles. In the implementation presented in method 100, a first step 101 includes synthesizing gold nanoparticles by reducing HAuCl₄. In some implementations, the reduction can occur by use of a reducing agent. For example, in one implementation, trisodiumcitrate may be used as a reducing agent. In addition, an optional second step 102 involves stabilizing the synthesized gold nanoparticles by mixing a surfactant with the synthesized gold nanoparticles. In a third step 103, an acid solution is added to the stabilized gold nanoparticles in order to form porous gold nanoparticles. Finally, an optional fourth step 104 can include separating the acid solution and excess reducing agent from the synthesized porous gold nanoparticles. Further details regarding the steps of method 100 are provided below.

As shown in FIG. 1, in some implementations, in the first step 101 of the method 100, the gold nanoparticles may be synthesized by first preparing an HAuCl₄ solution. The HAuCl₄ solution can then be heated to a temperature close to the boiling point of the HAuCl₄ solution in some implementations. In some cases, a reducing agent solution is then mixed with the heated HAuCl₄ solution to form the gold nanoparticles.

As one example, the first step 101 may involve synthesizing the gold nanoparticles by first preparing an HAuCl₄ solution with a concentration between about 650 μM and 850 μM. In addition, heating the HAuCl₄ solution can involve heating to a temperature close to the boiling point of the HAuCl₄ solution. Following the heating step, a reducing agent solution can be mixed with the heated HAuCl₄ solution to form the gold nanoparticles. In some implementations, the reducing agent solution can include sodium citrate solution. Furthermore, the reducing agent solution may have a concentration ranging between 1 μM and 3 mM in some implementations. The mixture can then be stirred and cooled to room temperature in one implementation.

With respect to the optional second step 102, according to one implementation, the synthesized gold nanoparticles may be stabilized by mixing the synthesized gold nanoparticles with a surfactant. For example, the sufactant can include polysorbate 20, polysorbate 40, polysorbate 60, polysorbate 80, cetyltrimethylammonium bromide (CTAB), and/or poly ethylene glycol p-(1,1,3,3-tetramethylbutyl)-phenyl ether. In some implementations, the surfactant may have a concentration between about 1 μM and 200 μM.

Referring to the third step 103 of method 100, in some implementations, an acid solution may be added to the stabilized gold nanoparticles to form porous gold nanoparticles. In one implementation, the acid solution can include HNO₃. In some implementations, the HNO₃ solution has a concentration ranging between about 1×10⁻⁶ M and 2 M that is mixed with the stabilized gold nanoparticles to form the porous gold nanoparticles.

Finally, with respect to the optional fourth step 104, excess acid solution and any excess reducing agent may be separated from the synthesized porous gold nanoparticles by centrifugation in different implementations.

### Example 1: Synthesizing Gold Nanoparticles

In this first example, gold nanoparticles were synthesized. To this end, 750 μL of a sodium citrate solution with a concentration of approximately 1% w/v was added to 10.5 mL of an HAuCl₄.3H₂O solution with a concentration of 735 μM at the boiling point of the HAuCl₄.3H₂O solution which is between 70° C. and 80° C. As another example, the ratio of sodium citrate solution:HAuCl₄.3H₂O solution can be understood to be approximately 1:10. The mixture of sodium citrate solution and the HAuCl₄.3H₂O solution was stirred vigorously until the color of the mixture changed to red. The mixture was then stirred for about 10 minutes and was left to cool down to room temperature. The obtained solution contained gold nanoparticles and is referred to hereinafter as GNP solution.

### Example 2: Synthesizing and Stabilizing Gold Nanoparticles

In this second example, gold nanoparticles were synthesized and then stabilized by a surfactant. To this end, 750 μL of a sodium citrate solution with a concentration of approximately 1% w/v was added to 10.5 mL of an HAuCl₄.3H₂O solution with a concentration of 735 μM at the boiling point of the HAuCl₄.3H₂O solution. The mixture of sodium citrate solution and the HAuCl₄.3H₂O solution was stirred vigorously until the color of the mixture changed to red. The mixture was then stirred for about 10 minutes and was left to cool down to room temperature, producing a GNP solution. Following this, 1 μL of Tween 20 with a concentration of approximately 0.9 M was mixed with 0.5 mL of the GNP solution. The GNP solution had a concentration of approximately 1.17 nM. As another example, the ratio of Tween 20 solution:GNP solution can be understood to be approximately 1:500. The obtained solution contained stabilized gold nanoparticles and is referred to hereinafter as the Tween-capped GNP solution.

### Example 3: Synthesizing Porous Gold Nanoparticles

In this third example, porous gold nanoparticles were synthesized according to the method 100 described with respect to FIG. 1. To this end, 750 pt of a sodium citrate solution with a concentration of approximately 1% w/v was added to 10.5 mL of an HAuCl₄.3H₂O solution with a concentration of 735 μM at the boiling point of the HAuCl₄.3H₂O solution. The mixture of sodium citrate solution and the HAuCl₄.3H₂O solution was stirred vigorously until the color of the mixture changed to red. The mixture was then stirred for about 10 minutes and was left to cool down to room temperature to obtain the GNP solution. Following this, 1 μL of an HNO₃ solution with a concentration of 0.14 M was mixed with the GNP solution to obtain a first solution containing porous gold nanoparticles referred to as porous GNP solution. Furthermore, 1 μL of Tween 20 with a concentration of approximately 0.9 M was mixed with 0.5 mL of the GNP solution to obtain the Tween-capped GNP solution. In addition, 1 μL of the HNO₃ solution with a concentration of 0.14 M was mixed with the Tween-capped GNP solution to obtain a second solution containing porous Tween-capped gold nanoparticles, refereed to herein as porous Tween-capped GNP solution.

### Example 4: Attaching DNA to the Synthesized Gold Nanoparticles

In this example, the GNP solution prepared as was described in detail in Example 1. In addition, Tween-capped GNP solution prepared as was described in detail in Example 2. Furthermore, GNP solution and porous Tween-capped GNP solution were prepared as described in Example 3. Each of these products were all functionalized with DNA. To this end, a thiolated DNA probe with a DNA sequence as set forth in SEQ ID No. 1, with a concentration of 0.08 μM, was separately added to 100 μL of each of the GNP solution, Tween-capped GNP solution, GNP solution, and porous Tween-capped GNP solution. In a next step, 10 mM phosphate buffer and 2M NaCl solution were added to each of the solutions, and the solutions were incubated at room temperature for approximately 2 hours.

The DNA loading capacity of porous Tween-capped gold nanoparticles was examined and the result was compared to that obtained by Tween-capped gold nanoparticles and gold nanoparticles. To this end, gold nanoparticles, Tween-capped gold nanoparticles, and porous Tween-capped nanoparticles were incubated with 0.08 μM thiolated DNA probe with a DNA sequence as set forth in SEQ ID No. 1. These solutions were incubated at room temperature and in the presence of phosphate buffer and NaCl. After about 2 hours, the mixtures were centrifuged and the DNA concentration in the obtained supernatant was measured by a NanoDrop spectrophotometer. The equation (A₀−A₁/A₀)×100 was employed to calculate the percentage of DNA loading. In this example, A₀ refers to the initial concentration of thiolated DNA and A₁ is the concentration of DNA after incubation for 2 hours.

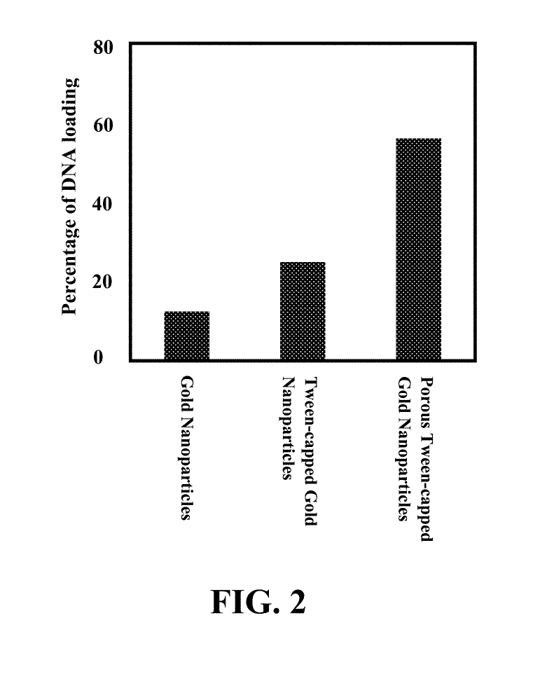

FIG. 2 presents percentages of DNA loading of the gold nanoparticles, the Tween-capped gold nanoparticles, and the porous Tween-capped nanoparticles. As shown in FIG. 2, the percentage of DNA loading for porous Tween-capped nanoparticles is approximately twice that of the percentage of DNA loading for Tween-capped gold nanoparticles and four times the percentage of DNA loading for gold nanoparticles.

### Example 5: Characterization

In this fifth example, gold nanoparticles were synthesized as described in Example 1, Tween-capped gold nanoparticles were synthesized as described in Example 2, porous gold nanoparticles and porous Tween-capped gold nanoparticles were synthesized as described in Example 3. Each of these products were characterized by Dynamic light scattering (DLS). TABLE 1 below reports the mean diameter size and the zeta potentials for the synthesized gold nanoparticles, Tween-capped gold nanoparticles, porous gold nanoparticles, and porous Tween-capped gold nanoparticles.

TABLE 1
Mean diameter and Zeta potential of gold nanoparticles,
Tween-capped gold nanoparticles, porous gold nanoparticles,
and porous Tween-capped gold nanoparticles.

| | Mean Diameter | Zeta Potential |
|---|---|---|
| Nanoparticles | (nm) | (mV) |
| Gold nanoparticles | 16.5 | −4.29 ± 0.24 |
| Tween-capped gold nanoparticles | 17.4 | −1.52 ± 0.11 |
| Porous gold nanoparticles | 17.6 | −11.07 ± 1.46 |
| Porous Tween-capped gold | 17.1 | −18.38 ± 2 |
| nanoparticles | | |

As shown in TABLE 1 above, the average diameter of gold nanoparticles prior to treatment with HNO₃ is 16.5 and the average diameter of Tween-capped gold nanoparticles prior to treatment with HNO₃ is 17.4 nm. The slight increase in the average diameter of Tween-capped gold nanoparticles relative to the gold nanoparticles may be understood to result at least in part from the Tween layer formed around the particles.

In addition, in TABLE 1 it can be seen that treatment with HNO₃ led to a small increase in mean diameter for the gold nanoparticles. In this example, the mean diameter of the gold nanoparticles following treatment with HNO₃ has increased to 17.6, about 1 nm larger than the diameter of the gold nanoparticles before treatment. In addition, the mean diameter of Tween-capped gold nanoparticles following treatment with HNO₃ is 17.1 nm. Thus, the size changes of Tween-capped gold nanoparticles after acid treatment may be considered negligible in this example.

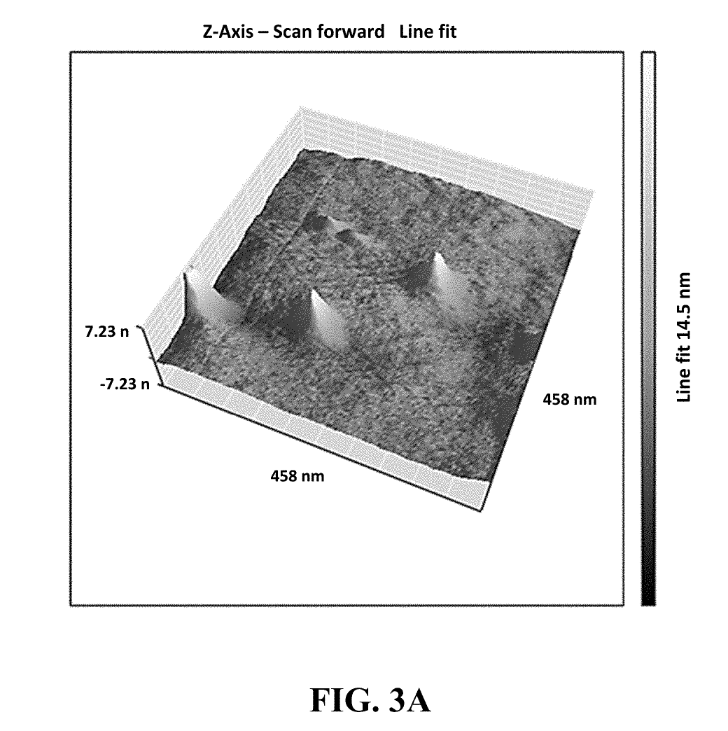

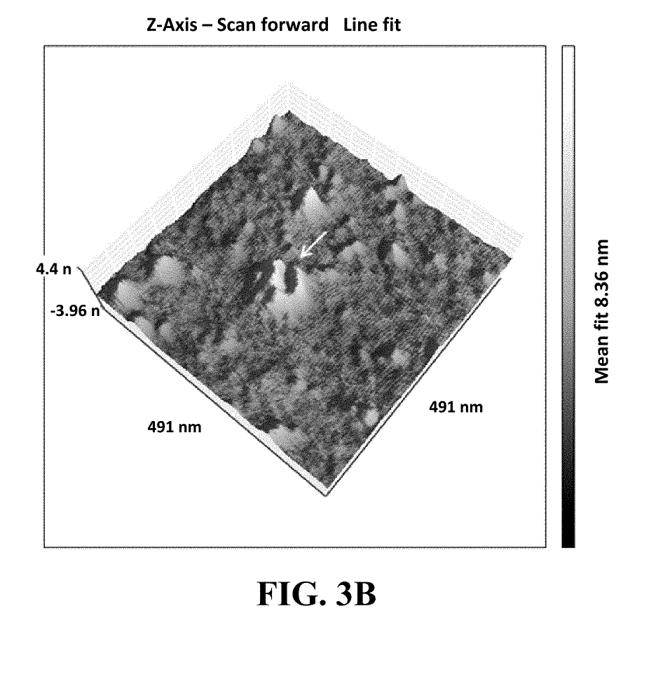

Referring next to FIG. 3A, a three-dimensional Atomic Force Microscopy (3D AFM) image of the gold nanoparticles as synthesized in Example 1 is illustrated. In addition, FIG. 3B illustrates a 3D AFM image of porous gold nanoparticles as synthesized in Example 3. Referring to FIG. 3A, the smooth peaks visible indicate the smooth surface of the synthesized gold nanoparticles. In FIG. 3B, the peak with an irregular surface visible indicates a porous surface for the porous gold nanoparticles as synthesized in Example 3. FIGS. 3A and 3B can be understood to demonstrate the success of the method in forming gold nanoparticles with a porous surface.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various implementations. This is for purposes of streamlining the disclosure and is not to be interpreted as reflecting an intention that the claimed implementations require more features than are expressly recited in each claim. Rather, as the following claims reflect, inventive subject matter lies in less than all features of a single disclosed implementation. Thus, the following claims are hereby incorporated into the Detailed Description, with each claim standing on its own as a separately claimed subject matter.

While various implementations have been described, the description is intended to be exemplary, rather than limiting and it will be apparent to those of ordinary skill in the art that many more implementations and implementations are possible that are within the scope of the implementations. Although many possible combinations of features are shown in the accompanying figures and discussed in this detailed description, many other combinations of the disclosed features are possible. Any feature of any implementation may be used in combination with or substituted for any other feature or element in any other implementation unless specifically restricted. Therefore, it will be understood that any of the features shown and/or discussed in the present disclosure may be implemented together in any suitable combination. Accordingly, the implementations are not to be restricted except in light of the attached claims and their equivalents. Also, various modifications and changes may be made within the scope of the attached claims.

What is claimed is:

1. A method for synthesizing porous gold nanoparticles, the method comprising:
synthesizing gold nanoparticles by reducing HAuCl₄;
mixing a surfactant with the synthesized gold nanoparticles, thereby stabilizing the synthesized gold nanoparticles;
adding an acid solution to the stabilized gold nanoparticles in order to form porous gold nanoparticles; and
separating the acid solution and excess reducing agent from the synthesized porous gold nanoparticles.

2. The method according to claim 1, wherein synthesizing gold nanoparticles by reducing HAuCl₄ includes the use of a reducing agent.

3. The method according to claim 2, wherein synthesizing gold nanoparticles by reducing HAuCl₄ by a reducing agent further includes:
preparing a solution of HAuCl₄;
heating the solution of HAuCl₄ to a temperature between 70° C. and 80° C.; and
mixing a solution of the reducing agent with the heated solution of HAuCl₄.

4. The method according to claim 3, wherein preparing a solution of HAuCl₄ includes preparing a solution of HAuCl₄ with a concentration between approximately 650 μM and 850 μM.

5. The method according to claim 3, wherein mixing the solution of the reducing agent with the heated solution of HAuCl₄ includes mixing the solution of the reducing agent with a concentration between approximately 1 μM and 3 mM with the heated solution of HAuCl₄.

6. The method according to claim 3, wherein the reducing agent includes trisodiumcitrate.

7. The method according to claim 1, wherein the acid solution includes an HNO₃ solution.

8. The method according to claim 1, wherein the surfactant is selected from the group consisting of polysorbate 20, polysorbate 40, polysorbate 60, polysorbate 80, cetyltrimethylammonium bromide (CTAB), and polyethylene glycol p-(1,1,3,3-tetramethylbutyl)-phenyl ether.

9. The method according to claim 1, wherein mixing the surfactant with the synthesized gold nanoparticles includes mixing the surfactant with a concentration between approximately 1 μM and 200 μM with the synthesized gold nanoparticles.

10. The method according to claim 1, wherein adding the acid solution to the stabilized gold nanoparticles in order to form porous gold nanoparticles includes adding the acid solution with a concentration between approximately 1×10⁻⁶ M and 2 M to the stabilized gold nanoparticles.

11. The method according to claim 1, wherein separating the acid solution and excess reducing agent from the synthesized porous gold nanoparticles is carried out by centrifugation.

12. The method according to claim 1, wherein the synthesized porous gold nanoparticles have an average diameter of 17.6 nm.

13. The method according to claim 1, wherein the synthesized porous gold nanoparticles have an average zeta potential of −11.07±1.46 mV.

14. The method according to claim 1, wherein the synthesized gold nanoparticles are smaller in diameter than the synthesized porous gold nanoparticles.

15. The method according to claim 1, wherein the synthesized gold nanoparticles are smaller in diameter than the synthesized porous gold nanoparticles.

16. The method according to claim 1, wherein the synthesized porous gold nanoparticles are approximately 1 nm larger in diameter than the synthesized gold nanoparticles.

17. The method according to claim 1, wherein the synthesized gold nanoparticles include a smoother outer surface relative to an outer surface of the synthesized porous gold nanoparticles.

18. The method according to claim 1, further including adding a first solution of Tween 20 to the stabilized gold nanoparticles to obtain a second solution containing porous Tween-capped gold nanoparticles.

19. The method according to claim 18, wherein DNA loading for the porous Tween-capped gold nanoparticles is at least three times greater than DNA loading for the synthesized gold nanoparticles.

20. The method according to claim 1, wherein the porous Tween-capped gold nanoparticles have an average diameter of approximately 17.1 nm.


SEQUENCE LISTING (1 sequence)

SEQ ID NO: 1 - DNA, 39 bp, Artificial Sequence
  Synthetic
aaaaaaaaacccctatcacgattagcattaatttttttt